(19) United States
(12) Patent Application Publication
(10) Pub. No.: US 2023/0313697 A1
(43) Pub. Date: Oct. 5, 2023

(54) GUIDE VANE IN GAS TURBINE ENGINE

(71) Applicant: Siemens Energy Global GmbH & Co. KG, München (DE)

(72) Inventors: Bengt Johansson, Linköping (SE); Antonio Pesare, Norrköping (SE)

(21) Appl. No.: 18/042,780

(22) PCT Filed: Sep. 2, 2021
(86) PCT No.: PCT/US2021/071347

§ 371 Date: Feb. 24, 2023

Related U.S. Application Data
(60) Provisional application No. 63/074,811, filed on Sep. 4, 2020.

(51) Int. Cl. F01D 9/04

(52) U.S. Cl. CPC F01D 9/047; F05D 2240/12; F05D 2300/611; F05D 2240/14

(57) ABSTRACT

A guide vane in a gas turbine engine includes an inner platform, an outer platform, and two vane airfoils extending between the inner platform and the outer platform and spaced apart from each other. The outer platform includes a front hook and a rear hook. A front locking feature and a rear locking feature are disposed on the front hook and the rear hook, respectively. Each of the two vane airfoils includes a pressure sidewall and a suction sidewall meeting upstream forming a leading edge. A downstream end of the suction sidewall extends downstream further from a downstream end of the pressure sidewall forming a trailing edge. An upstream side of the inner platform of the guide vane is longer than a downstream side of an inner platform of an upstream turbine blade of the gas turbine engine.

### BACKGROUND

An industrial gas turbine engine typically includes a compressor section, a turbine section, and a combustion section disposed therebetween. The compressor section includes multiple stages of rotating compressor blades and stationary compressor vanes. The combustion section typically includes a plurality of combustors.

The turbine section includes multiple stages of rotating turbine blades and stationary turbine vanes. Turbine blades and vanes often operate in a high temperature environment and are internally cooled.

### BRIEF SUMMARY

A guide vane in a gas turbine engine includes: an inner platform; an outer platform; a first vane airfoil extending between the inner platform and the outer platform; and a second vane airfoil extending between the inner platform and the outer platform and spaced apart from the first guide vane in the circumferential direction.

A guide vane in a gas turbine engine includes: an inner platform; an outer platform including a front hook and a rear hook; a vane airfoil extending between the inner platform and the outer platform; a front locking feature disposed on the front hook; and a rear locking feature disposed on the rear hook.

A guide vane in a gas turbine engine includes: an inner platform; an outer platform; and a vane airfoil extending between the inner platform and the outer platform, the vane airfoil including a pressure sidewall and a suction sidewall, an upstream end of the pressure sidewall and an upstream end of the suction sidewall meeting at a leading edge, a downstream end of the suction sidewall extending downstream further from a downstream end of the pressure sidewall, the downstream end of the suction sidewall forming a trailing edge, and the downstream end of the pressure sidewall meeting the suction sidewall at a location upstream from the trailing edge.

A gas turbine engine includes: a turbine blade including an inner platform; and a guide vane including an inner platform, the guide vane disposed downstream of the turbine blade, an upstream side of the inner platform of the guide vane interfacing with a downstream side of the inner platform of the turbine blade, the upstream side of the inner platform of the guide vane being longer than the downstream side of the inner platform of the turbine blade.

### BRIEF DESCRIPTION OF THE DRAWINGS

To easily identify the discussion of any particular element or act, the most significant digit or digits in a reference number refer to the figure number in which that element is first introduced.

FIG. 1 is a longitudinal cross-sectional view of a gas turbine engine 100 taken along a plane that contains a longitudinal axis or central axis.

FIG. 2 is a longitudinal cross-sectional view of a part of the turbine section.

FIG. 3 is a perspective view of a guide vane.

FIG. 4 is a perspective top view of a part of a guide vane.

FIG. 5 is a perspective view of a part of a guide vane.

FIG. 6 is a perspective front view of a guide vane.

FIG. 7 is a perspective view of a part of a guide vane.

FIG. 8 is an enlarged section view of a part of the guide vane of FIG. 7.

FIG. 9 is a perspective view of a part of a guide vane.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including”, “having”, and “comprising” as well as derivatives thereof, mean inclusion without limitation. The singular forms “a”, “an”, and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

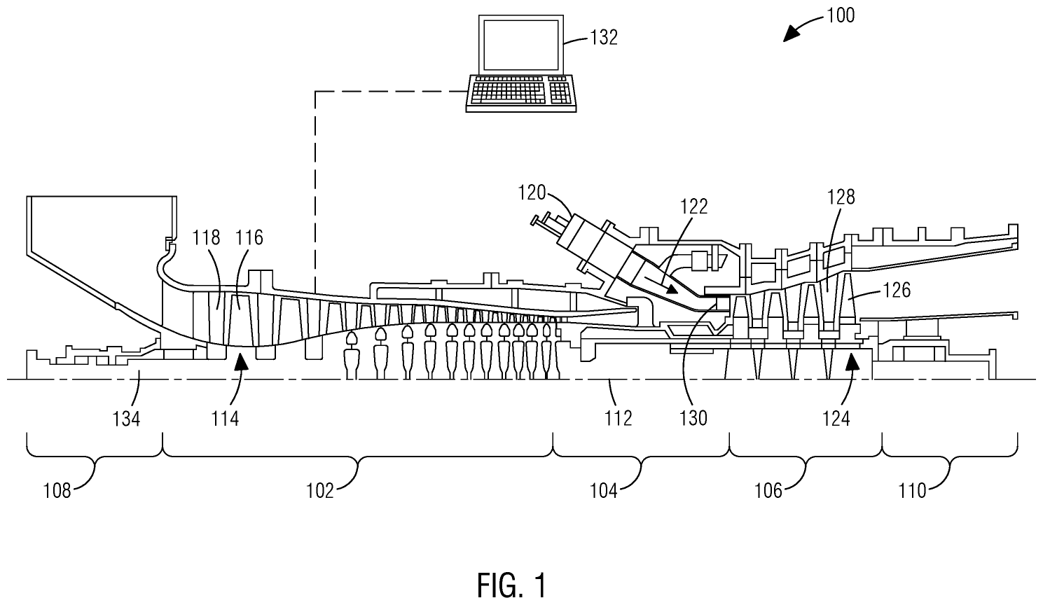

FIG. 1 illustrates an example of a gas turbine engine 100 including a compressor section 102, a combustion section 104, and a turbine section 106 arranged along a central axis 112. The compressor section 102 includes a plurality of compressor stages 114 with each compressor stage 114 including a set of rotating blades 116 and a set of stationary vanes 118 or adjustable guide vanes. A rotor 134 supports the rotating blades 116 for rotation about the central axis 112 during operation. In some constructions, a single one-piece rotor 134 extends the length of the gas turbine engine 100 and is supported for rotation by a bearing at either end. In other constructions, the rotor 134 is assembled from several separate spools that are attached to one another or may include multiple disk sections that are attached via a bolt or plurality of bolts.

The compressor section 102 is in fluid communication with an inlet section 108 to allow the gas turbine engine 100 to draw atmospheric air into the compressor section 102. During operation of the gas turbine engine 100, the compressor section 102 draws in atmospheric air and compresses that air for delivery to the combustion section 104. The illustrated compressor section 102 is an example of one compressor section 102 with other arrangements and designs being possible.

In the illustrated construction, the combustion section 104 includes a plurality of separate combustors 120 that each operate to mix a flow of fuel with the compressed air from the compressor section 102 and to combust that air-fuel mixture to produce a flow of high temperature, high pressure combustion gases or exhaust gas 122. Of course, many other arrangements of the combustion section 104 are possible.

The turbine section 106 includes a plurality of turbine stages 124 with each turbine stage 124 including a number of rotating turbine blades 126 and a number of stationary turbine vanes 128. The turbine stages 124 are arranged to receive the exhaust gas 122 from the combustion section 104 at a turbine inlet 130 and expand that gas to convert thermal and pressure energy into rotating or mechanical work. The turbine section 106 is connected to the compressor section 102 to drive the compressor section 102. For gas turbine engines 100 used for power generation or as prime movers, the turbine section 106 is also connected to a generator, pump, or other device to be driven. As with the compressor section 102, other designs and arrangements of the turbine section 106 are possible.

An exhaust portion 110 is positioned downstream of the turbine section 106 and is arranged to receive the expanded flow of exhaust gas 122 from the final turbine stage 124 in the turbine section 106. The exhaust portion 110 is arranged to efficiently direct the exhaust gas 122 away from the turbine section 106 to assure efficient operation of the turbine section 106. Many variations and design differences are possible in the exhaust portion 110. As such, the illustrated exhaust portion 110 is but one example of those variations.

A control system 132 is coupled to the gas turbine engine 100 and operates to monitor various operating parameters and to control various operations of the gas turbine engine 100. In preferred constructions the control system 132 is typically micro-processor based and includes memory devices and data storage devices for collecting, analyzing, and storing data. In addition, the control system 132 provides output data to various devices including monitors, printers, indicators, and the like that allow users to interface with the control system 132 to provide inputs or adjustments. In the example of a power generation system, a user may input a power output set point and the control system 132 may adjust the various control inputs to achieve that power output in an efficient manner.

The control system 132 can control various operating parameters including, but not limited to variable inlet guide vane positions, fuel flow rates and pressures, engine speed, valve positions, generator load, and generator excitation. Of course, other applications may have fewer or more controllable devices. The control system 132 also monitors various parameters to assure that the gas turbine engine 100 is operating properly. Some parameters that are monitored may include inlet air temperature, compressor outlet temperature and pressure, combustor outlet temperature, fuel flow rate, generator power output, bearing temperature, and the like. Many of these measurements are displayed for the user and are logged for later review should such a review be necessary.

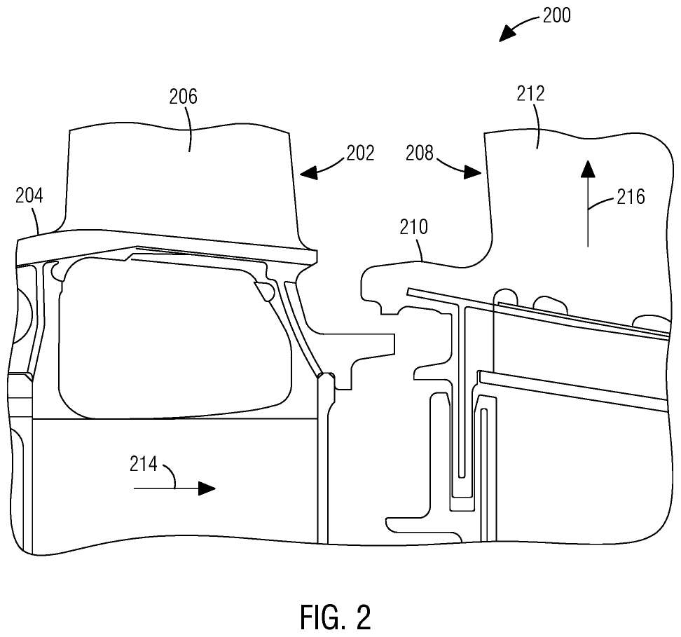

FIG. 2 is a longitudinal cross-sectional view of a part of a turbine section 200. The turbine section 200 includes a turbine blade 202 of one turbine stage 124 and a guide vane 208 of a downstream turbine stage 124 with respect to a flow direction 214. The turbine blade 202 include an inner platform 204 and a blade airfoil 206 extending on the inner platform 204 in a radial direction 216. The guide vane 208 includes an inner platform 210 and a vane airfoil 212 extending on the inner platform 210 in the radial direction 216. The inner platform 210 of the guide vane 300 interfaces with the inner platform 204 of the turbine blade 202. An upstream side of the inner platform 210 of the guide vane 208 is longer than a downstream side of the inner platform 204 of the turbine blade 202 such that the inner platform 210 of the guide vane 300 protrudes further upstream towards the turbine blade 202 and the inner platform 204 of the turbine blade 202 protrudes less downstream towards the guide vane 300. Such an arrangement reduces hot gas ingestion.

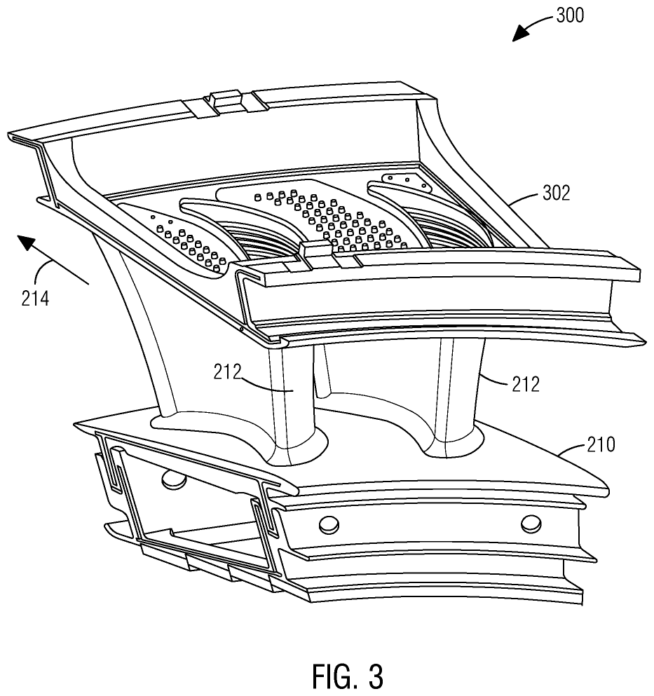

FIG. 3 is a perspective view of a guide vane 300. The guide vane 300 is one of a plurality of guide vanes 300 that are arranged next to each other circumferentially in the gas turbine engine 100 to define a row of stationary guide vanes 300.

The guide vane 300 includes an inner platform 210 and an outer platform 302. The guide vane 300 includes a first vane airfoil 212 and a second vane airfoil 212 extending between the inner platform 210 and the outer platform 302. The first vane airfoil 212 and the second vane airfoil 212 are spaced apart from each other in a circumferential direction. Such an arrangement of having two vane airfoils 212 in one guide vane 300 reduces air leakage between guide vanes 300. The arrangement may thus improve performance of the gas turbine engine 100. The arrangement also reduces numbers of guide vanes 300 in the circumferential direction. The arrangement may thus also reduce manufacturing cost. In the illustrated construction, the guide vane 300 includes two vane airfoils 212. It is possible that the guide vane 300 may include more than two vane airfoils 212 or any suitable numbers of vane airfoils 212.

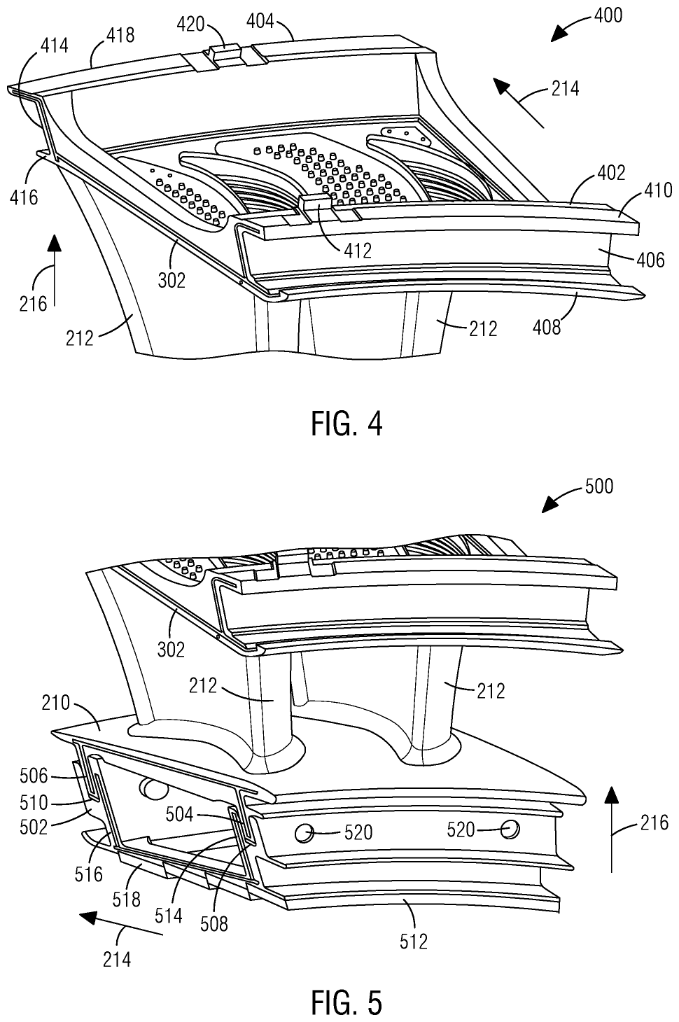

FIG. 4 is a perspective top view of a part of a guide vane 400. The guide vane 400 includes an outer platform 302. The outer platform 302 includes a front hook 402 and a rear hook 404 disposed at a front end and a rear end of the guide vane 400, respectively, with respect to the flow direction 214.

The front hook 402 has a general C-shape having an axially facing front side surface 406 extending in the radial direction 216. Axial or axially extending is in relation to the central axis 112 of the gas turbine engine 100. The front hook 402 includes a front inner arm 408 and a front outer arm 410 axially extending upstream from two radial ends of the front side surface 406. A front locking feature 412 is disposed on the front outer arm 410. The front locking feature 412 extends radially outward from the front outer arm 410. In the illustrated construction, the front locking feature 412 is located off the center of the front hook 402 in a circumferential direction. It is possible that the front locking feature 412 is located at the center of the front hook 402 or at any suitable locations of the front hook 402. The front locking feature 412 is a general rectangular shaped block. It is possible that the front locking feature 412 includes two separate general rectangular shaped blocks. It is also possible that the front locking feature 412 includes any suitable locking shapes.

The rear hook 404 has a similar configuration of the front hook 402. The rear hook 404 has a general C-shape having an axially facing rear side surface 414 extending in the radial direction 216. The rear hook 404 includes a rear inner arm 416 and a rear outer arm 418 axially extending downstream from two radial ends of the rear side surface 414. A rear locking feature 420 is disposed on the rear outer arm 418. The rear locking feature 420 extends radially outward from the rear outer arm 418. In the illustrated construction, the rear locking feature 420 is located at the center of the rear hook 404 in the circumferential direction. It is possible that the rear locking feature 420 is located off the center of the rear hook 404 or at any suitable locations of the rear hook 404. The rear locking feature 420 is a general rectangular shaped block. It is possible that the rear locking feature 420 includes two separate general rectangular shaped blocks. It is also possible that the rear locking feature 420 includes any suitable locking shapes.

The front locking feature 412 and the rear locking feature 420 limit the guide vane 300 from twisting. The front locking feature 412 and the rear locking feature 420 improve sealing capacity between an adjacent guide vane 300.

FIG. 5 is a perspective view of a part of a guide vane 500. The guide vane 500 includes an inter stage seal 502 coupled to the inner platform 210. The inter stage seal 502 has a base plate 512 and a front side wall 514 and a rear side wall 516 disposed at the front side and the rear side of the base plate 512, respectively. The front side wall 514 and rear side wall 516 extend radially from the base plate 512 towards the inner platform 210 forming a general U-shape towards the inner platform 210. The inter stage seal 502 has a front groove 508 formed in the front side wall 514. The inter stage seal 502 has a rear groove 510 formed in the rear side wall 516.

The inner platform 210 has a front inner rail 504 disposed at the front side of the inner platform 210 and extending radially towards the base plate 512 of the inter stage seal 502. The inner platform 210 has a rear inner rail 506 disposed at the rear side of the inner platform 210 and extending towards the base plate 512 of the inter stage seal 502. The inner platform 210, the front inner rail 504, and the rear inner rail 506 form a general U-shape toward the base plate 512. The inter stage seal 502 is coupled to the inner platform 210 by placing the front inner rail 504 within the front groove 508 and placing the rear inner rail 506 within the rear groove 510. Pins 520 are used to complete the connection between the inter stage seal 502 and the inner platform 210.

A seal (not shown in FIG. 5), such as a labyrinth seal, is disposed between the guide vane 500 and the rotor 134 (not shown in FIG. 5). A labyrinth seal includes a sealing surface and a seal ring coupled to the rotor 134 that interfaces with the sealing surface. By coupling the inter stage seal 502 to the inner platform 210 of the guide vane 500, the base plate 512 of the inter stage seal 502 forms a sealing surface 518 of the labyrinth seal. The sealing surface 518 has a stepped shape that steps down towards the sealing ring. A diameter of the sealing ring interfaces with the sealing surface 518 of the inter stage seal 502 is reduced in comparison of a diameter of the sealing ring interfacing with the inner platform 210 as a sealing surface. Such an arrangement reduces leakage between the guide vane 500 and the rotor 134. The inter stage seal 502 can be manufactured as a separate component from the guide vane 500 which provides manufacturing advantage.

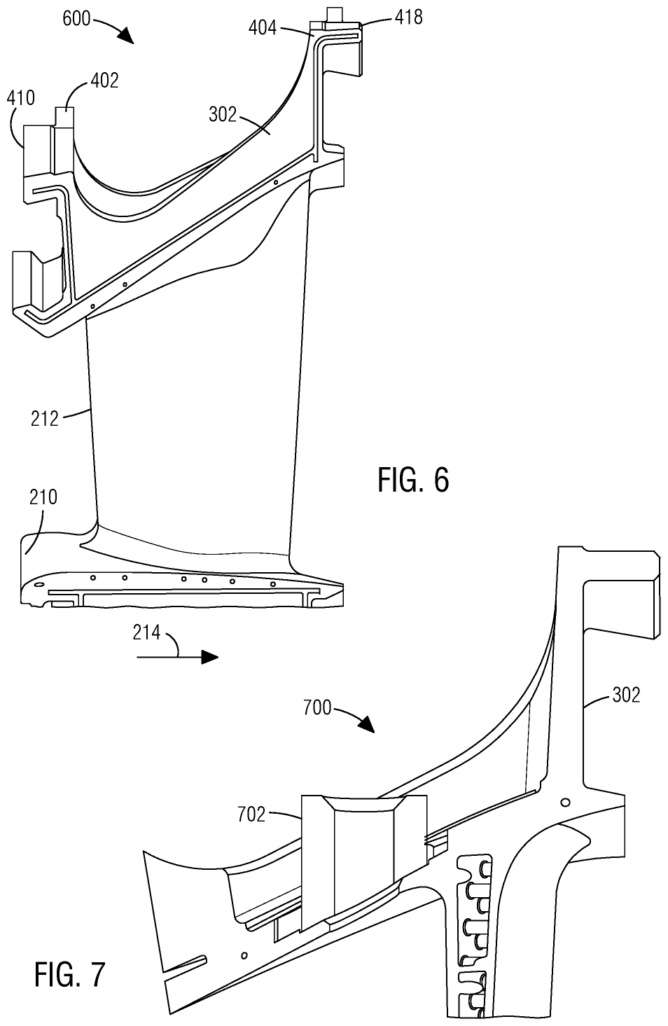

FIG. 6 is a side view of a guide vane 600. The outer platform 302 of the guide vane 600 has a concaved shape looking towards the outer platform 302. The front outer arm 410 of the front hook 402 extends upstream with respect to the flow direction 214. The front outer arm 410 may interface with a seal disposed on an adjacent upstream component of the guide vane 600 in the gas turbine engine 100. The upstream extending front outer arm 410 improves sealing between the guide vane 600 and the adjacent upstream component.

The rear outer arm 418 of the rear hook 404 extends downstream with respect to the flow direction 214. The rear outer arm 418 may also interface with a seal disposed on an adjacent downstream component of the guide vane 600 in the gas turbine engine 100. The downstream extending rear outer arm 418 improves sealing between the guide vane 600 and the adjacent downstream component.

FIG. 7 is a perspective view of a part of a guide vane 700. The guide vane 700 includes a borescope port 702 coupled to the outer platform 302 of the guide vane 700. The borescope port 702 provides a convenient access for the insertion of a borescope into an interior of the guide vane 700 to allow for inspection of the internal features and surfaces.

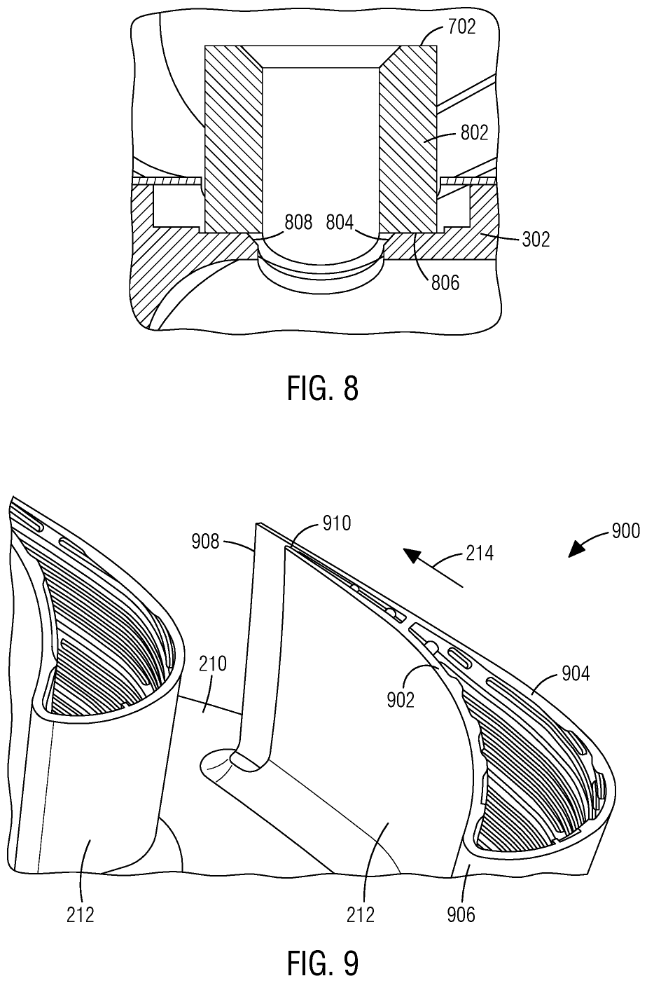

FIG. 8 is an enlarged section view of a part of the guide vane 700 of FIG. 7 showing the borescope port 702. The borescope port 702 has a general cylindrical shape. The borescope port 702 has an outer wall 802 surrounding a hollow interior. The outer platform 302 has an aperture 804 aligned with the hollow interior. A borescope can be inserted into an interior of the guide vane 700 through the hollow interior for inspection of the internal features and surfaces. A surface of the outer wall 802 contacts the outer platform 302 around the aperture 804. A coating 808 may be applied to a surface of the aperture 804 of the outer platform 302.

The borescope port 702 is attached to the outer platform 302 by brazing. The brazing is performed at a brazing area 806 between the surface of the outer wall 802 contacting the outer platform 302 and the outer platform 302. The brazing area 806 at the surface of the outer wall 802 contacting the outer platform 302 and the outer platform 302 reduces spallation of the coating 808.

FIG. 9 is a perspective view of a part of guide vane 900. The guide vane 900 includes a vane airfoil 212 extending on the inner platform 210. The vane airfoil 212 includes a concave shaped pressure sidewall 902 and a convex shaped suction sidewall 904. An upstream end of the pressure sidewall 902 and an upstream end of the suction sidewall 904 meet forming a leading edge 906. A downstream end of the suction sidewall 904 extends further than a downstream end of the pressure sidewall 902. The downstream end of the suction sidewall 904 forms a trailing edge 908. The downstream end of the pressure sidewall 902 meets the pressure sidewall 902 at a location 910 that is upstream from the trailing edge 908. Such an arrangement makes a thin trailing edge 908. The arrangement improves a performance of the gas turbine engine 100.

It should be noted that FIG. 1 to FIG. 9 illustrate many features of a guide vane and these features can be used together or separate from one another on any guide vane. Thus, there is no requirement that the guide vane includes any or all of the features and there is no limit to the combinations of features for a particular design.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

### LISTING OF DRAWING ELEMENTS

100 gas turbine engine
102 compressor section
104 combustion section
106 turbine section
108 inlet section
110 exhaust portion
112 central axis
114 compressor stage
116 rotating blade
118 stationary vane
120 combustor
122 exhaust gas
124 turbine stage
126 rotating turbine blade
128 stationary turbine vane
130 turbine inlet
132 control system
134 rotor
200 turbine section
202 turbine blade
204 inner platform
206 blade airfoil
208 guide vane
210 inner platform
212 vane airfoil
214 flow direction
216 radial direction
300 guide vane
302 outer platform
400 guide vane
402 front hook
404 rear hook
406 front side surface
408 front inner arm
410 front outer arm
412 front locking feature
414 rear side surface
416 rear inner arm
418 rear outer arm
420 rear locking feature
500 guide vane
502 inter stage seal
504 front inner rail
506 rear inner rail
508 front groove
510 rear groove
512 base plate
514 front side wall
516 rear side wall
518 sealing surface
520 pins
600 guide vane
700 guide vane
702 borescope port
802 outer wall
804 aperture
806 brazing area
808 coating
900 guide vane
902 pressure sidewall
904 suction sidewall
906 leading edge
908 trailing edge
910 location

1. A guide vane in a gas turbine engine, the guide vane comprising:
an inner platform;
an outer platform;
a first vane airfoil extending between the inner platform and the outer platform; and
a second vane airfoil extending between the inner platform and the outer platform and spaced apart from the first vane airfoil in a circumferential direction.

2. The guide vane of claim 1, wherein the outer platform comprises a front hook and a front locking feature disposed on the front hook.

3. The guide vane of claim 2, wherein the front hook comprises a front side surface, a front outer arm, and a front inner arm, and wherein the front outer arm extends upstream from a radial outer end of the front side surface and the front inner arm extends upstream from a radial inner end of the front side surface.

4. The guide vane of claim 1, wherein the outer platform comprises a rear hook and a rear locking feature disposed on the rear hook.

5. The guide vane of claim 4, wherein the rear hook comprises a rear side surface, a rear outer arm, and a rear inner arm, and wherein the rear outer arm extends downstream from a radial outer end of the rear side surface and the rear inner arm extends downstream from a radial inner end of the rear side surface.

6. The guide vane of claim 1, wherein the first vane airfoil comprises a pressure sidewall and a suction sidewall, wherein a downstream end of the suction sidewall extends downstream further than a downstream end of the pressure sidewall, and wherein the downstream end of the suction sidewall forms a trailing edge.

7. The guide vane of claim 6, wherein the downstream end of the pressure sidewall meets the suction sidewall at a location upstream from the trailing edge.

8. The guide vane of claim 1, further comprising an inter stage seal coupled to the inner platform.

9. The guide vane of claim 8, wherein the inter stage seal comprises a base plate, a front side wall, and a rear side wall that extends towards the inner platform from a front side and a rear side of the base plate, respectively.

10. The guide vane of claim 9, wherein the inner platform comprises a front inner rail and a rear inner rail extending towards the base plate from a front side and a rear side of the inner platform, respectively.

11. The guide vane of claim 10, wherein the inner inter stage seal comprises a front groove and a rear groove formed in the front side wall and the rear side wall, respectively, and wherein the front inner rail is placed in the front groove and the rear inner rail is placed in the rear groove.

12. The guide vane of claim 1, further comprising a borescope port coupled to the outer platform.

13. The guide vane of claim 12, wherein the borescope port comprises an outer wall that surrounds a hollow interior, wherein the outer platform comprises an aperture aligned with the hollow interior, and wherein a surface of the outer wall contacts the outer platform.

14. The guide vane of claim 13, wherein a coating is applied to a surface of the aperture.

15. The guide vane of claim 1, wherein the outer platform comprises a concave shape.

16. A guide vane in a gas turbine engine, the guide vane comprising:
an inner platform;
an outer platform comprising a front hook and a rear hook;
a vane airfoil extending between the inner platform and the outer platform;
a front locking feature disposed on the front hook; and
a rear locking feature disposed on the rear hook.

17. The guide vane of claim 16, wherein the front hook comprises a front side surface and a front outer arm and a front inner arm extending upstream from two ends of the front hook.

18. The guide vane of claim 16, wherein the rear hook comprises a rear side surface and a rear outer arm and a rear inner arm extending upstream from two ends of the rear hook.

19. (canceled)

20. A gas turbine engine comprising:
a turbine blade comprising an inner platform; and
a guide vane comprising an inner platform, the guide vane disposed downstream of the turbine blade, an upstream side of the inner platform of the guide vane interfacing with a downstream side of the inner platform of the turbine blade, the upstream side of the inner platform of the guide vane being longer than the downstream side of the inner platform of the turbine blade.
